(19) United States
(12) Patent Application Publication
(10) Pub. No.: US 2025/0196744 A1
(43) Pub. Date: Jun. 19, 2025

(54) USER SUPPORT ASSEMBLY FOR VEHICLES

(71) Applicant: Ford Global Technologies, LLC, Dearborn, MI (US)

(72) Inventors: David D. Friske, Wolverine Lake, MI (US); Marc Silva Kondrad, Macomb Township, MI (US); Michael Joseph Niksa, Royal Oak, MI (US); Kevin Wayne Preuss, Ortonville, MI (US); Sangram Laxman Tamhankar, Farmington Hills, MI (US); Kevin VanNieulande, Fraser, MI (US); Keith Weston, Canton, MI (US)

(73) Assignee: Ford Global Technologies, LLC, Dearborn, MI (US)

(21) Appl. No.: 18/541,739

(22) Filed: Dec. 15, 2023

(51) Int. Cl. B60N 2/90; B60N 2/879

(52) U.S. Cl. CPC B60N 2/914; B60N 2/879; B60N 2002/981

(57) ABSTRACT

A user support comprises at least one cushioned component having a porous lattice matrix formed by an additive process. The porous lattice matrix may comprise a plurality of integrally formed tubular portions. A sound passageway may be integrally formed in the porous lattice matrix to carry sound from a remote source to an opening in the user support.

### FIELD OF THE DISCLOSURE

The present invention generally relates to a user support assembly for vehicles and more particularly to a user support assembly having one or more cushioned components having a porous lattice matrix.

### BACKGROUND OF THE DISCLOSURE

Various types of user supports have been developed to support operators and/or passengers of a motor vehicle during operation.

### SUMMARY OF THE DISCLOSURE

An aspect of the present disclosure is a user support assembly, including a frame having a lower portion having upper and lower sides, and a back portion having front and rear sides. A cushioned component is disposed on the frame. The cushioned component has an outer side that resiliently deforms when a force is applied to the outside by a user. The cushioned component comprises a one-piece integral porous lattice matrix formed by a plurality of interconnected links defining a plurality of cells disposed throughout the porous lattice matrix and interconnected with one another to form a plurality of layers of cells. At least a first cell of a first layer of cells comprises a curved upper link with a concave lower surface, a convex upper surface, and opposite ends that are integrally joined to curved upper links of a pair of lower cells. The curved upper links of the pair of lower cells have convex upper surfaces that define lower surfaces of the first cell. The pair of lower cells are disposed in a lower layer of cells below the first row of cells. An upper layer of cells is disposed above the first layer of cells and includes a pair of upper cells. Each upper cell has a curved upper link with an end that is integrally joined to the curved upper link of the first cell.
The upper link of the first cell may comprise a horizontally extending upper wall of the first cell.
The upper wall of the first cell may include a plurality of openings therethrough.
The upper links of the pair of lower cells may comprise horizontally extending upper walls of the pair of lower cells, and the upper links of the pair of upper cells may comprise horizontally extending upper walls of the pair of upper cells.
The cells of the first layer of cells, the upper layer of cells, and the lower layer of cells may comprise elongated to the other structures.
The walls of the cells of the first layer of cells, the upper layer of cells, and the lower layer of cells may have substantially uniform thickness.
The cells of the first layer of cells, the upper layer of cells, and the lower layer of cells may have identical sizes and shapes.
At least some cells of the first layer of cells, the upper layer of cells, and the lower layer of cells may have resiliences that are not identical to other cells of the first layer of cells, the upper layer of cells, and the lower layer of cells, whereby at least a first portion of the outer side of the cushioned component may have a greater resilience than a second portion of the outer side of the cushioned component.
The cushioned component may be positioned on the back portion of the frame, and the outer side of the cushioned component may face a forward direction. The cushioned component may include at least one tubular sound passageway that is integrally formed with the porous lattice matrix. The at least one tubular sound passageway may have an upper opening on the outer side of the cushioned component, a lower opening on a lower portion of the cushioned component, and a central portion extending through the porous lattice matrix between upper and lower openings, whereby sound entering the lower opening is transmitted through the tubular sound passageway and exits at the upper opening.

Another aspect of the present disclosure is a user support assembly including a frame having a lower portion and an upright back portion. The user support assembly further includes a cushioned component disposed on the frame. The cushioned component has a resilient homogeneous one-piece integral porous lattice matrix comprising a plurality of elongated cells. At least four of the elongated cells may be disposed about an integral junction. Each of the elongated cells includes an upper sidewall and first and second lower sidewalls. The upper sidewalls and the first and second lower sidewalls have upwardly facing convex surfaces and downwardly facing lower surfaces. The elongated cells include vertically aligned upper and lower tubular portions, and horizontally aligned first and second tubular portions. The first and second lower sidewalls of the upper tubular portions comprise portions of the upper sidewall of the horizontally aligned first and second tubular portions. The junction is formed at an intersection of the edges of the upper sidewalls of the horizontally aligned first and second tubular portions and a central portion of the upper sidewalls of the lower tubular portion. First and second opposite edge portions of the upper sidewalls of the upper tubular portions intersect the upper sidewall of the horizontally aligned first and second tubular portions, respectively, whereby the upper sidewall and the first and second lower sidewalls of the at least four tubular portions resiliently deform when a force is applied to the cushioned component.
The at least four tubular portions may, optionally have the same cross-sectional shapes.
The upper sidewalls of the at least four tubular portions may optionally have the same thicknesses.
The first and second lower sidewalls of the at least four tubular portions may optionally have the same thicknesses.
The upwardly facing convex surfaces of the upper sidewalls of the at least four tubular portions may be cylindrical.
The upper sidewall of the at least two of the tubular portions may have thicknesses that are not identical.
The tubular portions may be parallel to one another.
The upper sidewall of the at least one tubular portion may include one or more openings therethrough.
The cushioned component may optionally include an upper web on an upper side of the cushioned component, wherein the upper web is integrally formed with the upper sidewalls of horizontally adjacent tubular portions forming an upper layer of tubular portions of the cushioned component.
Each tubular portion may have a centerline, and the upper web may include a plurality of grooves extending parallel to the upper layer of tubular portions. The grooves may be located midway between the centerlines of adjacent tubular portions of the upper layer of tubular portions.
The cushioned component may optionally include a lower web on a lower side of the cushioned component, wherein the lower web is integrally formed with lower edge portions of the upper sidewalls of horizontally adjacent lower tubular portions of a lower layer of tubular portions of the cushioned component, whereby the tubular portions of the lower layer of tubular portions have a semicircular cross-sectional shape.
The one-piece integral porous lattice matrix is optionally homogenous.

Another aspect of the present disclosure is a user support assembly including a frame and a cushioned component supported by the frame. The cushioned component has an outer side, and includes a porous lattice matrix formed by an additive process. The cushioned component may include at least one tubular sound passageway that is integrally formed with the porous lattice matrix. At least one tubular sound passageway may have an upper opening on the outer side of the cushioned component, a lower opening on a lower portion of the cushioned component, and a central portion extending through the porous lattice matrix between the upper and lower openings, whereby sound entering the lower opening is transmitted through the tubular sound passageway and exits at the upper opening.
The tubular sound passageway and the porous lattice matrix may comprise a homogenous one-piece polymer structure.
The porous lattice matrix may include a plurality of horizontally extending tubular portions.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of a user support according to an aspect of the present disclosure;

FIG. 2 is a perspective view of a user support according to another aspect of the present disclosure;

FIG. 3 is an exploded perspective view of the user support of FIG. 1;

FIG. 4 is a partially schematic cross sectional view of the user support of FIG. 1 taken along the line IV-IV;

FIG. 5 is a perspective view of a cushioned component according to an aspect of the present disclosure;

FIG. 5A is a perspective view of a cushioned component going to another aspect of the present disclosure;

FIG. 6 is a cross sectional view of the cushioned component of FIG. 5 taken along the line VI-VI;

FIG. 6A is an enlarged fragmentary view of the matrix of FIG. 6;

FIG. 7 is a graph showing force versus displacement curves for a plurality of lattice configurations;

FIG. 7A is a partially schematic perspective view of a lattice structure according to an aspect of the present disclosure;

FIG. 7B is a partially schematic perspective view of a lattice structure according to an aspect of the present disclosure;

FIG. 7C is a partially schematic perspective view of a lattice structure according to an aspect of the present disclosure;

FIG. 7D is a partially schematic perspective view of a lattice structure according to an aspect of the present disclosure;

FIG. 7E is a partially schematic perspective view of a lattice structure according to an aspect of the present disclosure;

FIG. 7F is a partially schematic perspective view of a lattice structure according to an aspect of the present disclosure;

FIG. 7G is a partially schematic perspective view of a lattice structure according to an aspect of the present disclosure;

FIG. 7H is a partially schematic perspective view of a lattice structure according to an aspect of the present disclosure;

FIG. 7I is a partially schematic perspective view of a lattice structure according to an aspect of the present disclosure;

FIG. 8 is a schematic view of a vehicle including a user support according to another aspect of the present disclosure; and

FIG. 9 is a fragmentary enlarged view of a portion of the user support of FIG. 8.

### DETAILED DESCRIPTION OF PREFERRED EMBODIMENTS

The present application is related to U.S. patent application Ser. No. ______, entitled “VEHICLE USER SUPPORT INCLUDING UPPER HOOD MODULE” (Attorney Docket No. 84805763), filed on even date herewith, and U.S. patent application Ser. No. ______, entitled “VEHICLE USER SUPPORT INCLUDING FLEXIBLE LIGHTING FEATURES” (Attorney Docket No. 84805805), filed on even date herewith, the entire contents of which are incorporated herein by reference.

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

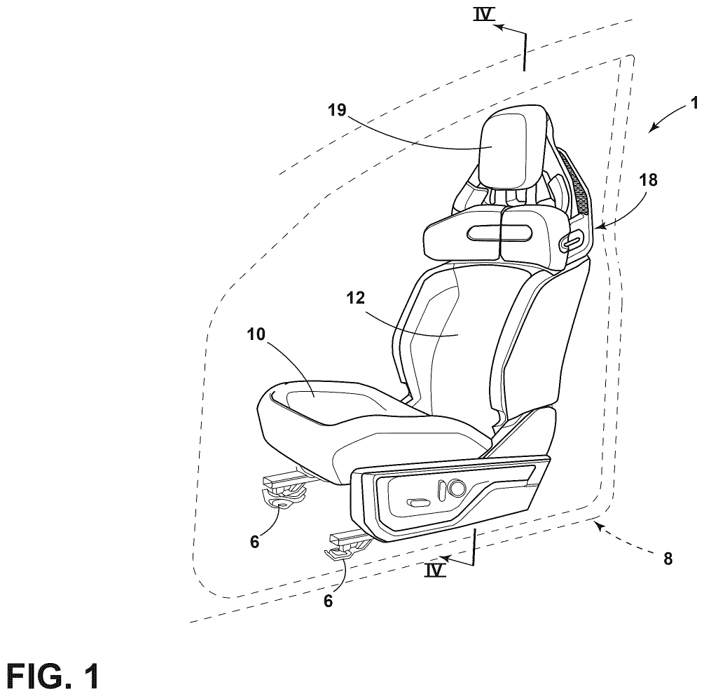

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

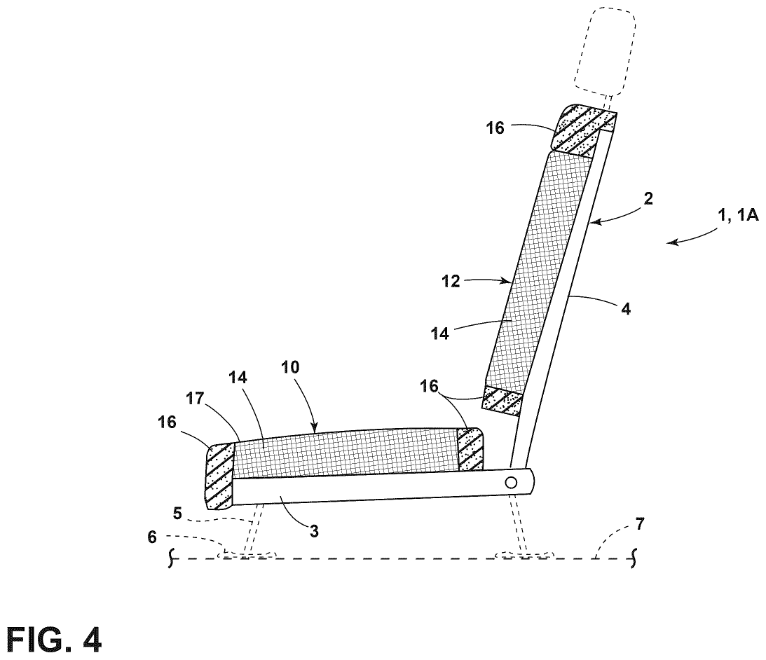

With reference to FIG. 1, a seat or user support 1 according to an aspect of the present disclosure includes a frame 2 (see also FIG. 4) having a lower portion 3 and an upright back portion 4. A support assembly 5 may include attachment structures 6 that are configured to secure the user support 1 to a floor 7 of a motor vehicle 8 (see also FIG. 4). One or more cushioned components 10, 12 may be disposed on the frame 2. With reference to FIG. 4, the cushioned components 10, 12 comprise a one-piece integral porous lattice matrix 14 that may be formed by an additive process whereby the one-piece integral porous lattice matrix 14 is homogeneous. As discussed below, at least a portion of porous lattice matrix 14 may be resilient to provide a cushion for users. The user support 1 optionally includes foam 16 that may form an opening or passageway 17 whereby the lattice matrix 14 may be at least partially surrounded by foam 16. Foam 16 is not required, however, and the porous lattice matrix 14 may comprise the sole resilient user support surface.

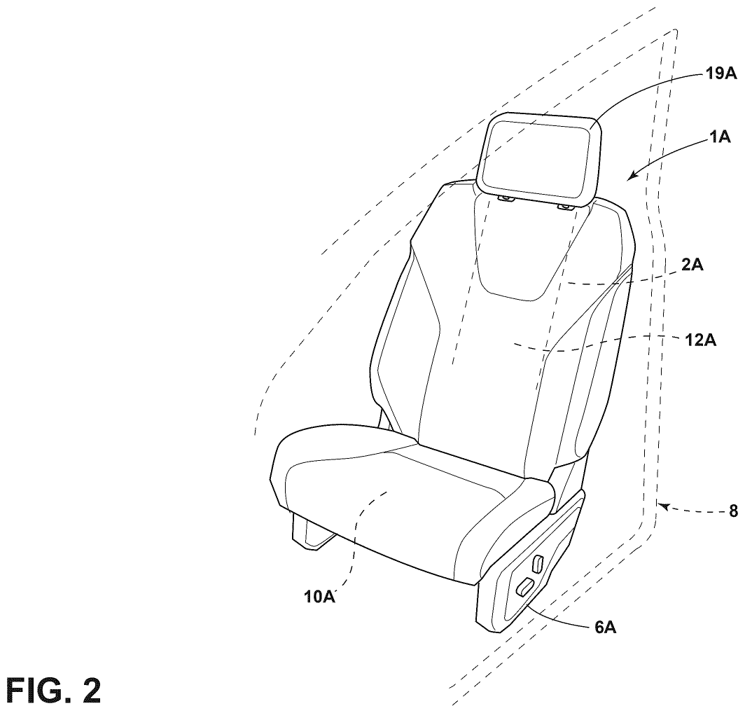

A seat or user support 1A (FIG. 2) according to another aspect of the present disclosure may include a frame 2A and cushioned components 10A and 12A having a one-piece integral porous lattice matrix 14. User support 1 (FIG. 1) includes an upper module 18 and upper cushion 19, whereas user support 1A (FIG. 2) includes an upper cushion 19A, but not an upper module. It will be understood that the present disclosure is not limited to the arrangements of FIGS. 1 and 2.

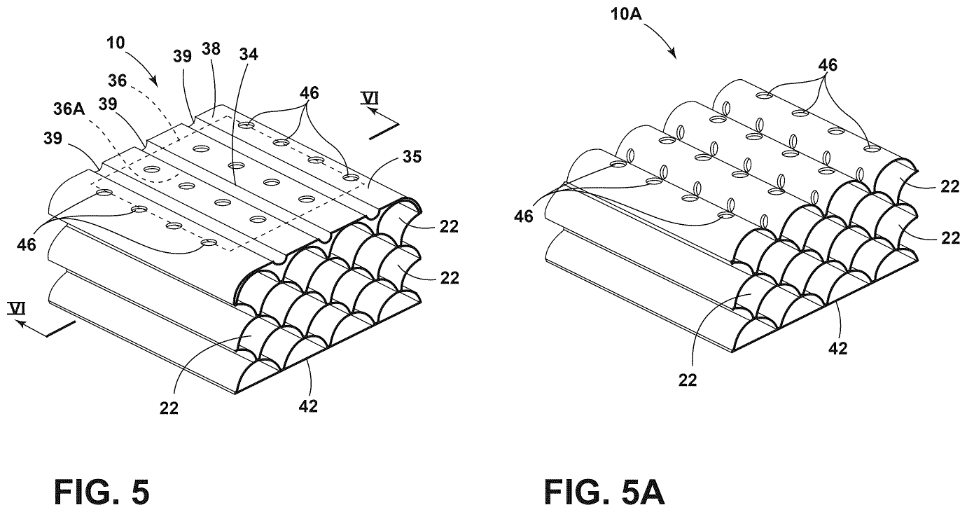

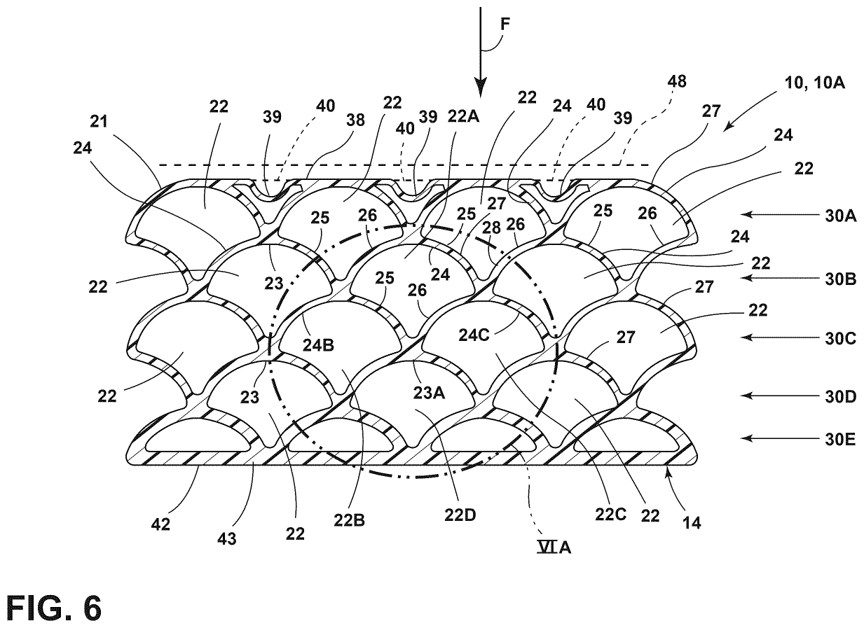

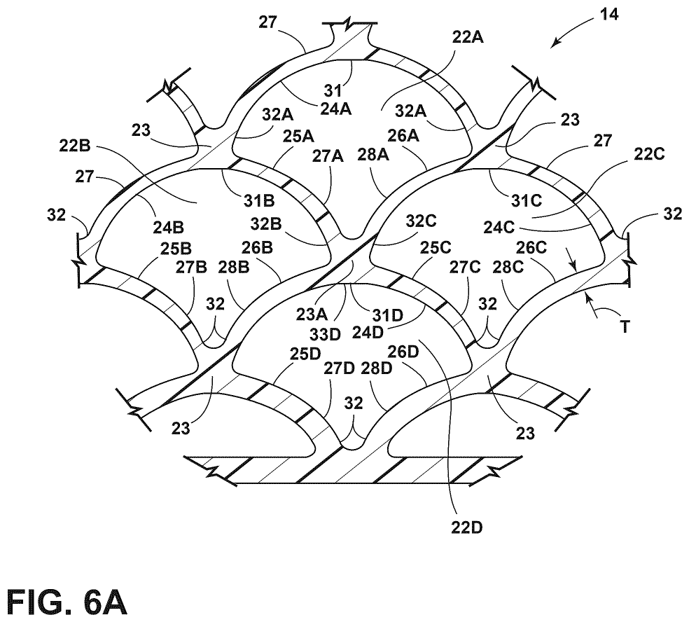

With further reference to FIGS. 5, 6, and 6A, cushioned component 10 may comprise a plurality of cells 22 having curved links that may optionally be in the form of sidewalls whereby cells 22 may be tubular. As discussed below, cushioned component 10A (FIG. 5A) is similar to cushioned component 10 (FIG. 5), and further includes optional openings 46 to provide increased resilience if required for a particular application. The cushioned components 10 and 10A comprise one-piece integral structures that may be formed by an additive process (“3D printed”) from polymer or other material whereby the one-piece integral porous lattice matrix 14 comprises a homogeneous structure. With reference to FIG. 6, each tubular portion 22 may have an upper curved link such as sidewall 24, and first and second lower curved links such as sidewalls 25 and 26. Upper sidewalls 24 have upwardly facing convex surfaces 27, and first and second lower sidewalls 25 and 26 have upwardly facing convex surfaces 28, and 29, respectively. The tubular portions 22 form a plurality of layers 30A-30E such that upper sidewalls 24 of each tubular portion 22 also comprises lower sidewalls 25 and 26 of tubular portions 22 in a vertically adjacent layer of tubular portions 22.

With reference to FIG. 6A, the porous lattice matrix 14 may include four tubular portions 22A-22D disposed about a junction 23A, wherein each of the tubular portions 22A-22D has an upper sidewall 24 and first and second lower sidewalls 25 and 26, respectively. The four tubular portions 22A-22D include vertically aligned upper and lower tubular portions 22A, 22D, and horizontally aligned tubular portions 22B, 22C. The junction 23A is formed at an intersection of opposite edges 32B, 32C of upper sidewalls 24B, 24C of tubular portions 22B, 22C, and a central portion 33D of the upper sidewall 24D of lower tubular portion 22D. Opposite edge portions 32A of the upper sidewall 24A of the upper tubular portion 22A intersect central portions of the upper sidewalls 24B, 24C of tubular portions 22B, 22C, whereby sidewalls of the tubular portions 22A-22D resiliently deform when a force “F” is applied to the cushioned component 10. It will be understood that tubular portions 22A-22D represent one region of porous lattice matrix 14, and the pattern formed by tubular portions 22A-22D may be repeated throughout porous lattice matrix 14.

As shown in FIG. 6A, the sidewalls extending around each tubular portion 22 may have a substantially uniform thickness “T.” However, the thickness “T” of each sidewall may be non-uniform, and some of the sidewalls may have increased thickness relative to other sidewalls. Thus, the thicknesses of the sidewalls forming the lattice matrix 14 may be non-uniform to provide a desired resilience and/or regions having different resiliences. For example, with reference to FIG. 5, a central portion 34 of cushioned component 10 (bounded by dash line 36) could include sidewalls having different thicknesses than the sidewalls of a peripheral region 35 such that the central portion 34 and peripheral portion 35 have different resiliences (stiffnesses) to provide different force (e.g. pressure) at a given displacement (deformation) or different deformation for a given force (pressure). In general, forces per unit area (pressures) on cushioned component 10 due to contact with a user may be measured or predicted, and the stiffnesses of different regions of the cushioned component 10 may be adjusted to provide desired characteristics (e.g. increased comfort). Thus, different areas or regions of cushioned component 10 may have virtually any desired stiffnesses, and the contours of the regions may have virtually any shape, including curved or irregular shapes as shown by the dashed line 36A.

The cushioned component 10 may optionally include an upper web 38 (FIGS. 5, 6) on upper side 41 of cushioned component 10. Upper web 38 is optional and the entire upper surface 27 of upper sidewalls 24 of the top row 30A of tubular portions 22 may be exposed. Web 38 may include a plurality of grooves 39 that open upwardly. Alternatively, the upper web 38 may be substantially planar (without grooves 39) as shown by the dashed lines 40. The upper web 38 on upper side 41 of cushioned component 10 may be integrally formed by additive processes (e.g. 3D printing) with the material of the lattice matrix 14. The cushioned component 10 may also include a lower web 42 that is integrally formed with the lattice matrix 14 on lower side 43 of cushioned component 10. The cushioned component 10 or 10A may optionally include one or more openings 46 (see also FIG. 5A) that extend through upper web 38 and/or one or more upper sidewalls 24 of lattice matrix 14. In general, the sidewalls of lattice/matrix 14 may include openings 46 only in selected locations to provide increased resilience in areas of the selected locations. The openings 46 may be configured to provide for ventilation, or to reduce stiffness in selected areas, and/or to provide other features as required for a particular application.

Referring again to FIG. 6, an optional upper layer 48 may be disposed on upper side 41 of cushioned component 10. Upper layer 48 may comprise, for example, fabric, foam, or other resilient material. For example, upper layer 48 may comprise a fabric by itself, or the upper layer 48 may comprise an upper layer of fabric and a thin sheet or layer of foam below the fabric. However, the cushioned component 10 does not necessarily include an upper layer 48, and the upper surface of the lattice matrix 14 is exposed if there is no upper layer 48.

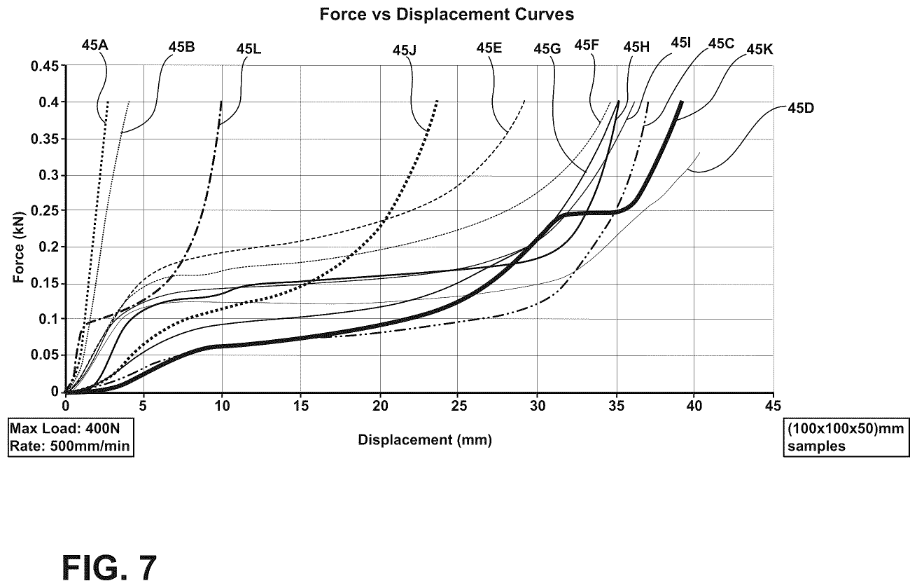

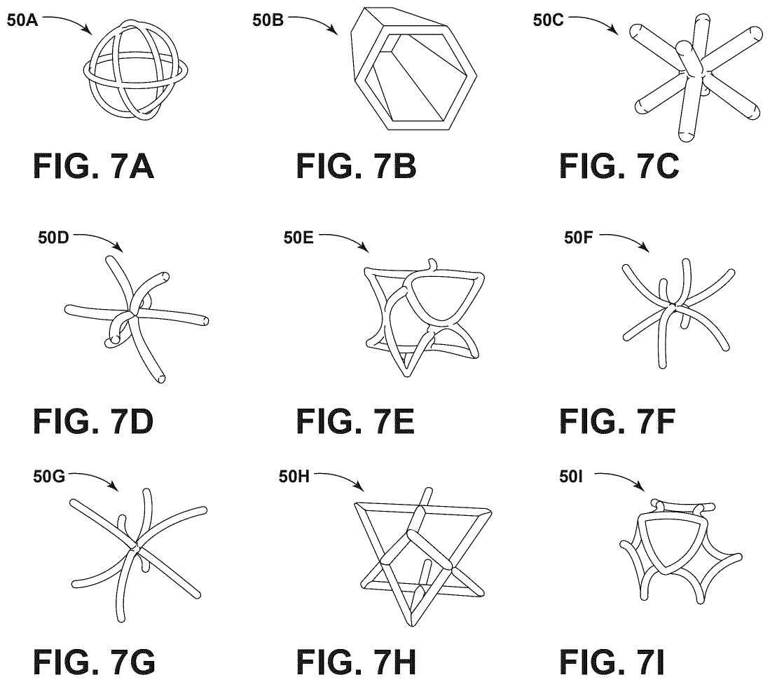

As discussed above, the configuration of the porous lattice matrix 14 of cushioned component 10 may be varied as required to provide a desired overall stiffness and/or specific stiffnesses in selected regions of cushioned component 10. With further reference to FIG. 7, various materials may have force versus displacement curves as shown by the lines 45A-45L. Lines 45J-45L represent conventional foam cushions that do not include a porous lattice matrix. Lines 45A-45I correspond to the lattice cell structures 50A-50I, respectively, of FIGS. 7A-7I. One or more of lattices 50A-50I may be utilized to form porous lattice matrix 14. It will be understood that the force curves of lines 45A-45I may be different than the results shown in FIG. 7 if the materials and/or sizes of the individual links forming the lattice cells 50A-50I (FIGS. 7A-7I) are varied. Lines 45A-45I show that lattice structures 50A-50I may have significantly different force versus displacement characteristics. For example, the lattice cell structures 50A and 50B (corresponding to lines 45A and 45B) have generally linear force versus displacement, and both reach a force of about 0.4 kN prior to a displacement of 5 mm. As another example, the force curve 45E for lattice cell structure 50E initially slopes upwardly at a relatively rapid rate until about 5 mm, and then increases at a more gradual rate until about 20 mm displacement, and the line 45E then increases more rapidly.

A porous lattice matrix 14 may include a plurality of interconnected cell structures (e.g. one or more of cell structures 50A-50I) that are formed by the additive process. Lattice matrix 14 may include different lattice cells in different areas to provide different resiliences. For example, porous lattice matrix 14 may include lattice cells 45A in areas requiring increased stiffness, and may include lattice cells 45D in areas requiring decreased stiffness. Also, the dimensions of the links of lattice cells 50A-50I may be increased or decreased to adjust the stiffness. For example, the diameter of one or more links of a lattice cell 50C could be increased or decreased as required. As discussed, the polymer material utilized to form the cells of porous lattice matrix 14 may also be selected to provide a desired stiffness.

In general, the cushioned component 10 may include a lattice matrix 14 comprising one or more of the lattice cell structures as shown in FIGS. 5, 6A, and 7A-7I as required for a particular application. For example, if a particular application requires a relatively stiff lattice, a lattice cell structure 50A or 50B corresponding to lines 45A and 45B, respectively (FIG. 7) may be selected. However, if a reduced force versus displacement is required, one of the other lattice structures (e.g. lattice 50C or 50D corresponding to lines 45C and 45D) may be selected. Also, lattice matrix 14 may include more than one lattice structure to provide varying resilience in different regions of cushioned component 10.

As noted above, the lattice matrix 14 may be formed utilizing an additive manufacturing process (3D printing). The lattice matrix 14 may be fabricated from virtually any suitable material. The process may comprise multi-jet fusion (MJF), fusion deposition modeling (FDM), polymer laser sintering (SLS), or other suitable process. The material utilized to form the lattice matrix 14 is preferably a polymer material such as thermoplastic polyurethane (TPU) or other suitable material.

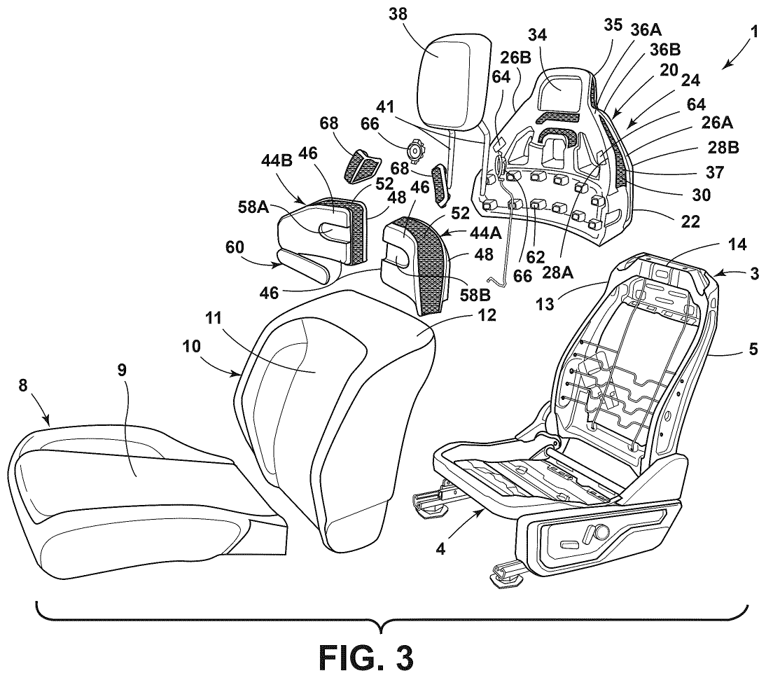

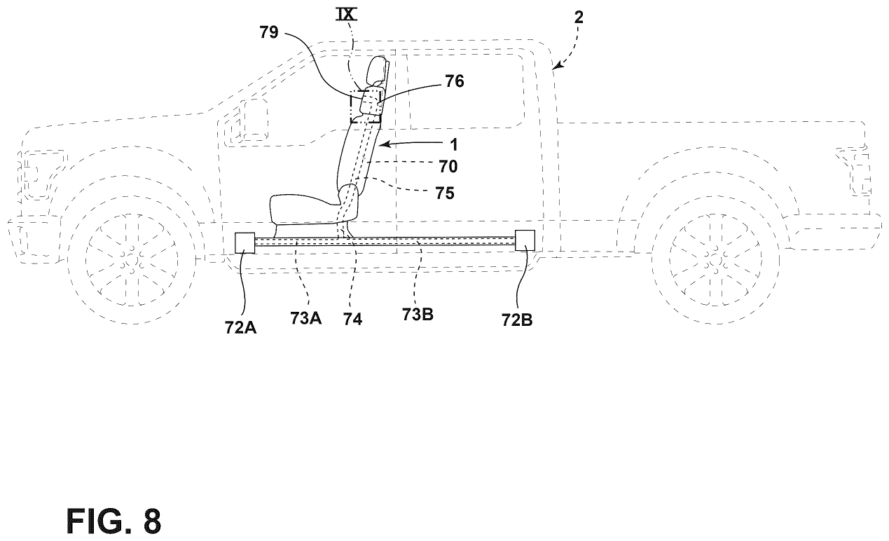

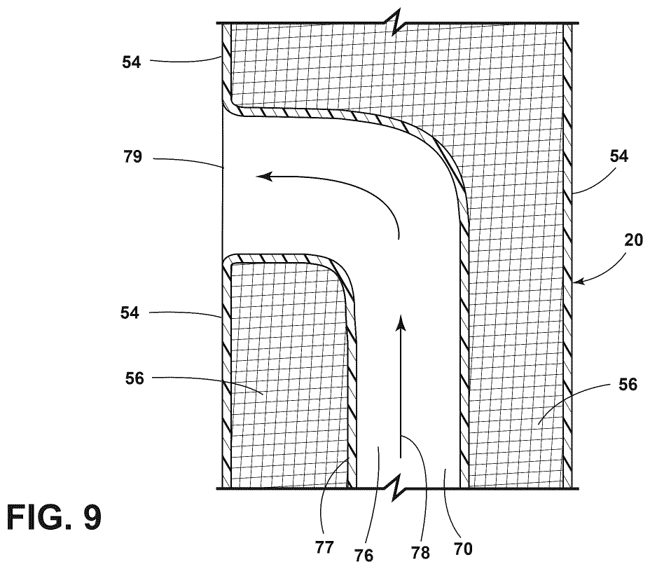

With further reference to FIGS. 8 and 9 user support 1 may include a sound tube or audio passageway 70 that carries sound from one or more sources of sound 72A and 72B. The passageway 70 may include one or more sections in the form of tubes 73A and 73B that are connected to an upwardly extending portion 75 at a junction 74. An upper portion 76 (FIG. 9) of the passageway 70 may comprise a tubular structure formed by a layer 77 of material. Layer 77 may be integrally formed with lattice 56 whereby sound 78 travels through the upper portion 76 of passageway 70 and exits at an upper opening 79. The opening 79 may be formed in a similar manner and provided at a similar location as the openings 64 (FIG. 3) for speaker 66. Sources 72A and/or 72B may comprise virtually any source of sound as described in U.S. Pat. No. 11,280,303, the entire contents of which are hereby incorporated herein by reference. For example, source 72A may comprise an induction of an internal combustion engine located under a hood of vehicle 2 if vehicle 2 has a front engine configuration, and source 72B may comprise an exhaust system of an internal combustion engine of vehicle 2. If vehicle 2 has a rear or mid engine configuration, source 72A may comprise an induction of an internal combustion engine, and source 72A may be located in a rear portion of vehicle 2.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A user support assembly, comprising:
a frame having a lower portion having upper and lower sides, and a back portion having front and rear sides; and
a cushioned component disposed on the frame, the cushioned component having an outer side that resiliently deforms when a force is applied to the outer side by a user, the cushioned component comprising a one-piece integral porous lattice matrix formed by a plurality of interconnected curved links defining a plurality of cells disposed throughout the porous lattice matrix, wherein the curved links form a plurality of layers of cells, wherein the curved links have concave lower surfaces and convex upper surfaces, wherein opposite ends of the curved links are integrally joined to curved links of adjacent cells, and wherein opposite ends of the curved links of each layer are also integrally joined to central portions of curved links of cells in an adjacent layer of cells below each layer of cells.

2. The user support assembly of claim 1, wherein:
the curved links of the cells comprise horizontally extending walls.

3. The user support assembly of claim 2, wherein:
the wall of at least one cell includes a plurality of openings therethrough.

4. The user support assembly of claim 2, wherein:
the curved links of the cells in vertically adjacent upper and lower layers of cells comprise horizontally extending upper and lower walls of the cells in the lower and upper layers of the cells, respectively.

5. The user support assembly of claim 4, wherein:
the cells comprise elongated tubular structures.

6. The user support assembly of claim 5, wherein:
the walls of the cells have substantially uniform thickness.

7. The user support assembly of claim 6, wherein:
the cells of the each layer of the cells have identical sizes and shapes.

8. The user support assembly of claim 5, wherein:
at least some of the cells of a first layer of cells, the cells of a layer of cells above the first layer of cells, and the cells of a layer of cells below the first layer of cells have resiliences that are not identical to other cells, whereby at least a first portion of the outer side of the cushioned component has a greater resilience than a second portion of the outer side of the cushioned component.

9. The user support assembly of claim 1, wherein:
the cushioned component is positioned on the back portion of the frame, and the outer side of the cushioned component faces a forward direction;
the cushioned component includes at least one tubular sound passageway that is integrally formed with the porous lattice matrix;
the at least one tubular sound passageway having an upper opening on the outer side of the cushioned component, a lower opening on a lower portion of the cushioned component, and a central portion extending through the porous lattice matrix between the upper and lower openings, whereby sound entering the lower opening is transmitted through the tubular sound passageway and exits at the upper opening.

10. A user support assembly comprising:
a frame having a horizontal lower portion and an upright back portion; and
a cushioned component disposed on the frame, the cushioned component having a homogeneous one-piece integral porous lattice matrix comprising a plurality of tubular portions, including a region with four tubular portions disposed about an integral junction, wherein the four tubular portions comprise vertically aligned upper and lower tubular portions, and horizontally aligned first and second tubular portions, each of the four tubular portions having an upper sidewall having first and second opposite edge portions and first and second lower sidewalls, each upper sidewall and each first and second lower sidewall having an upwardly facing convex surface and a downwardly facing lower surface, and wherein the first and second lower sidewalls of the upper tubular portion comprise first and second portions of the upper sidewalls of the horizontally aligned first and second tubular portions, and wherein the integral junction is formed at an intersection of edge portions of the upper sidewall of the horizontally aligned first and second tubular portions, and a central portion of the upper sidewall of the lower tubular portion, and wherein the first and second opposite edge portions of the upper sidewall of the upper tubular portion intersect central portions of the upper sidewalls of the horizontally aligned first and second tubular portions, respectively, whereby the sidewalls of the four tubular portions resiliently deform when a force is applied to the cushioned component.

11. The user support assembly of claim 10, wherein:
the four tubular portions have the same cross-sectional shape.

12. The user support assembly of claim 11, wherein:
the upper sidewalls of the four tubular portions have the same thickness.

13. The user support assembly of claim 12, wherein:
the first and second lower sidewalls of each of the four tubular portions have the same thickness.

14. The user support assembly of claim 10, wherein:
the upwardly facing convex surface of the upper sidewall of each of the four tubular portions is cylindrical;
the upper sidewall of at least two of the tubular portions have thicknesses that are not identical; and
the tubular portions are parallel to one another.

15. The user support assembly of claim 10, wherein:
the upper sidewall of at least one tubular portion includes a plurality of openings therethrough.

16. The user support assembly of claim 10, wherein:
the cushioned component includes an upper web on an upper side of the cushioned component, and wherein the upper web is integrally formed with upper sidewalls of horizontally adjacent tubular portions.

17. The user support assembly of claim 16, wherein:
each tubular portion has a centerline;
the porous lattice matrix includes an upper layer of tubular portions and a lower layer of tubular portions;
the upper web includes a plurality of upwardly opening grooves extending parallel to the upper layer of tubular portions, wherein the grooves are located between the centerlines of adjacent tubular portions of the upper layer of tubular portions; and
the cushioned component includes a lower web on a lower side of the cushioned component, wherein the lower web is integrally formed with the tubular portions of the lower layer of tubular portions.

18. A user support assembly comprising:
a frame; and
a cushioned component supported by the frame, the cushioned component having an outer side and including a porous lattice matrix formed by an additive process;
wherein the cushioned component includes at least one tubular sound passageway that is integrally formed with the porous lattice matrix, the at least one tubular sound passageway having an upper opening on the outer side of the cushioned component, a lower opening on a lower portion of the cushioned component, and a central portion extending through the porous lattice matrix between the upper and lower openings, whereby sound entering the lower opening is transmitted through the tubular sound passageway and exits at the upper opening.

19. The user support assembly of claim 18, wherein:
the tubular sound passageway and the porous lattice matrix comprise a homogenous one-piece polymer structure.

20. The user support assembly of claim 18, wherein:
the porous lattice matrix includes a plurality of horizontally extending tubular portions.
